(19) United States
(12) Patent Application Publication
(10) Pub. No.: US 2023/0226642 A1
(43) Pub. Date: Jul. 20, 2023

(54) SURFACE TREATMENT METHOD

(71) Applicant: SINTOKOGIO, LTD., Nagoya-shi, Aichi (JP)

(72) Inventors: Fumiaki KUMENO, Nagoya-shi, Aichi (JP); Toshiya TSUJI, Nagoya-shi, Aichi (JP); Yuta SAITO, Nagoya-shi, Aichi (JP)

(73) Assignee: SINTOKOGIO, LTD., Nagoya-shi, Aichi (JP)

(21) Appl. No.: 18/008,506

(22) PCT Filed: Jun. 24, 2021
(86) PCT No.: PCT/JP2021/024000

§ 371 Date: Dec. 6, 2022

(30) Foreign Application Priority Data
Jun. 30, 2020 (JP) 2020-112566

(51) Int. Cl. B23K 26/356; B21D 31/06

(52) U.S. Cl. CPC B23K 26/356; B21D 31/06

(57) ABSTRACT

A surface treatment method includes: a first step of applying a plane wave-shaped shock wave to a workpiece to cause high-density transition to occur in a material structure of the workpiece; and a second step of applying a spherical wave-shaped shock wave or a pressure due to physical contact to the workpiece after the first step for plastic deformation of the workpiece.

### TECHNICAL FIELD

The present disclosure relates to a surface treatment method.

### BACKGROUND ART

Patent Literature 1 discloses a surface treatment method in which a shot peening treatment is performed for a steel part, and a part of a residual austenite structure of the steel part is transformed into a martensite structure. According to the surface treatment method, a compressive residual stress can be applied to a surface of the steel part. Accordingly, even when a crack occurs on a surface when the steel part is used, progress of the crack is suppressed.

### CITATION LIST

### Patent Literature

Patent Literature 1: International Publication WO 2017/154964

### SUMMARY OF INVENTION

### Technical Problem

In this technical field, there is a demand for a surface treatment method capable of further improving fatigue strength of a workpiece.

Therefore, an object of the present disclosure is to provide a surface treatment method capable of further improving fatigue strength of a workpiece.

### Solution to Problem

A surface treatment method according to an aspect of the present disclosure includes the following steps.

First step: a plane wave-shaped shock wave is applied to a workpiece to cause high-density transition to occur in a material structure of a workpiece.

Second step: the workpiece after the first step is subjected to plastic deformation. This plastic deformation is performed by applying a spherical wave-shaped shock wave or a pressure due to physical contact to the workpiece.

In the surface treatment method, since the material structure is subjected to the high-density transition in the first step, it is possible to allow a surface layer portion of the workpiece to have a surface on which a crack is less likely to progress. In addition, since the workpiece is subjected to the plastic deformation in the second step, the surface of the workpiece can be set as a surface on which a starting point of the crack is less likely to occur. Accordingly, it is possible to provide the surface and the surface layer portion in which occurrence of a crack and progress of the crack are suppressed to the workpiece by combining the first step and the second step. Accordingly, fatigue strength of the workpiece can be further improved.

In the second step, the material structure of the workpiece may be transformed by subjecting the workpiece to plastic deformation. In this case, the surface of the workpiece can be reliably set as a surface on which the starting point of a crack is less likely to occur.

In the second step, the spherical wave-shaped shock wave may be applied to the workpiece by physical collision. In this case, the workpiece can be easily subjected to the plastic deformation.

An effective processing depth of the workpiece in the first step may be deeper than an effective processing depth of the workpiece in the second step. In this case, it is possible to apply a residual compressive stress to a deeper position from the surface of the workpiece in comparison to a case of carrying out only the second step.

An effective processing depth of the workpiece in the first step is 0.3 mm or greater, and an effective processing depth of the workpiece in the second step may be 50 μm or less. In this case, it is possible to apply a residual compressive stress up to a depth of 0.3 mm or greater from the surface of the workpiece. In addition, it is possible to reliably apply the residual compressive stress to a depth of 50 μm or less from the surface of the workpiece.

In the second step, the material structure of the workpiece may be subjected to deformation-induced martensite transformation. In this case, volume expansion occurs in a metal structure, and strain is caused to occur in a parent phase. According to this, it is possible to apply the residual compressive stress.

In the first step, the plane wave-shaped shock wave may be applied to the workpiece by irradiating the workpiece with a laser wave, and in the second step, the spherical wave-shaped shock wave may be applied to the workpiece by performing shot peening to the workpiece. In this case, since the laser wave is a high-speed shock wave having directionality, inter-lattice strain is applied in a depth direction. Accordingly, the residual compressive stress can be applied to a deep position. The shot peening applies inter-lattice strain in the vicinity of a contact point of the surface of the workpiece due to physical contact. According to this, it is possible to apply the residual compressive stress to the vicinity of the contact point.

In the second step, a residual austenite amount of the workpiece may be reduced by 10 vol % or greater. In this case, since 10 vol % or greater of residual austenite can be subjected to martensite transformation, it is possible to sufficiently apply the residual compressive stress.

### Advantageous Effects of Invention

According to the present disclosure, it is possible to provide a surface treatment method capable of further improving fatigue strength of a workpiece.

### BRIEF DESCRIPTION OF DRAWINGS

FIG. 1 is a flowchart illustrating a surface treatment method according to an embodiment.

FIG. 2 is a configuration diagram illustrating a laser irradiation device that is used in a first step.

FIG. 3 is a configuration diagram illustrating a shot peening device that is used in a second step.

FIG. 4 is a view illustrating an arc-height measuring method.

FIG. 5 is a view illustrating a method of performing shot peening for a sample.

FIG. 6 is a graph illustrating measurement results of a residual stress.

FIG. 7 is a graph illustrating measurement results of a residual austenite amount.

FIG. 8 is a graph illustrating measurement results of hardness.

FIG. 9 is a graph illustrating measurement results of a KAM value.

### DESCRIPTION OF EMBODIMENTS

Hereinafter, an embodiment of the invention will be described in detail with reference to the accompanying drawings. Note that, in description, the same reference numeral will be given to the same element or an element having the same function, and redundant description thereof will be omitted.

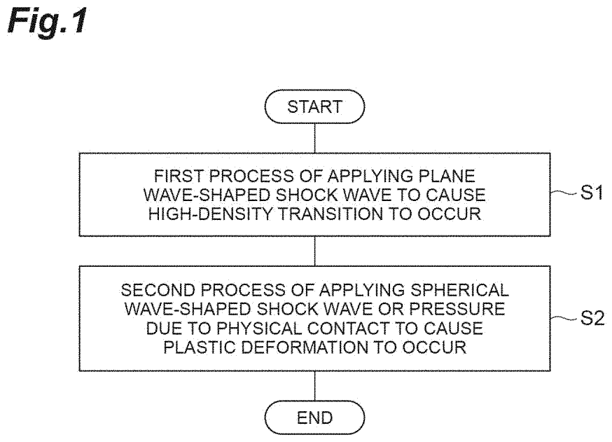

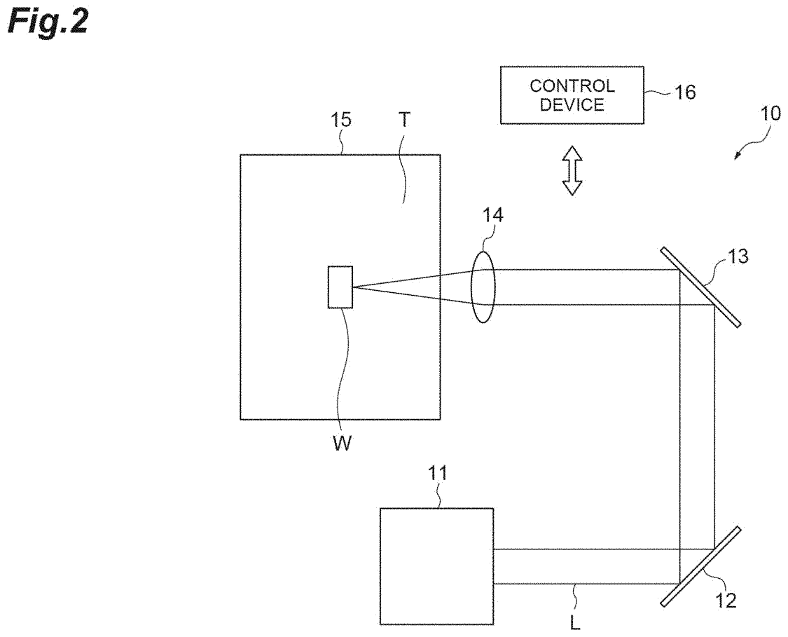

FIG. 1 is a flowchart illustrating a surface treatment method according to the embodiment. The surface treatment method according to the embodiment is a method of performing a surface treatment for a workpiece W that is an object to be treated (refer to FIG. 2), and includes a first step S1 and a second step S2 as illustrated in FIG. 1. For example, the workpiece W is formed from a steel material. For example, the workpiece W is a vacuum carburizing material, a gas carburizing material, or a stainless steel. Hereinafter, the first step S1 and the second step S2 will be described.

### First Step

The first step S1 is a step of applying a plane wave-shaped shock wave to the workpiece W to cause high-density transition to occur in a material structure of the workpiece W. The plane wave-shaped shock wave is a shock wave that propagates through the inside of the workpiece W in a plane wave shape. Since the plane wave-shaped shock wave has directionality, and propagates in one direction, the plane wave-shaped shock wave propagates up to deep position from a surface of the workpiece W, and applies strong shock to the workpiece W. In the first step S1, the workpiece W is subjected to plastic deformation by applying the plane wave-shaped shock wave, and high-density transition occurs in a material structure of a surface layer portion of the workpiece W. The high-density transition represents that a density becomes higher due to movement or the like of a lattice defect in comparison to a density before the treatment. As a result, in the first step S1, a residual compressive stress is applied to the surface layer portion of the workpiece W, and a hardened layer is formed, and thus fatigue strength (fracture strength) of the workpiece W can be improved.

According to the first step S1 using the plane wave-shaped shock wave, it is possible to apply the residual compressive stress to a deep position from the surface of the workpiece W. When a depth to which a residual stress (here, a residual compressive stress) is applied is set as an effective processing depth, an effective processing depth d1 of the workpiece W in the first step S1 is, for example, 0.3 mm or greater. The effective processing depth d1 may be 1.0 mm or greater. For example, the effective processing depth d1 is 3.0 mm or less. Note that, the depth to which the residual stress is applied is a depth at which a residual stress of the workpiece W subjected to a residual stress application treatment matches a residual stress of a non-treated workpiece W, or a depth at which the matching is assumed to be established. In a case where the residual stress of the non-treated workpiece W is 0 MPa, the depth to which the residual stress is applied is a depth at which the residual stress of the workpiece W subjected to the residual stress application treatment becomes 0 MPa, or a depth at which the residual stress is assumed as 0 MPa.

Examples of a method of applying the plane wave-shaped shock wave to the workpiece W include a method of irradiating the workpiece W with a laser wave by laser peening or the like. That is, in the first step S1, for example, laser peening is performed on the surface of the workpiece W, and the workpiece W is irradiated with the laser wave to apply the plane wave-shaped shock wave to the workpiece W.

FIG. 2 is a configuration diagram illustrating a laser irradiation device that is used in the first step. As illustrated in FIG. 2, a laser irradiation device 10 includes a laser oscillator 11, reflection mirrors 12 and 13, a condensing lens 14, a processing stage 15, and a control device 16. The laser oscillator 11 is a device that oscillates a pulse laser beam L. The reflection mirrors 12 and 13 transfer the pulse laser beam L oscillated by the laser oscillator 11 to the condensing lens 14. The condensing lens 14 condenses the pulse laser beam L to a processing position of the workpiece W. The processing stage 15 is a water tank filled with a medium formed from a transparent liquid T such as water. The workpiece W is disposed at the processing stage 15 in a state of being immersed in the transparent liquid T.

The laser irradiation device 10 is controlled by the control device 16. For example, the control device 16 is configured as a motion controller such as a programmable logic controller (PLC) and a digital signal processor (DSP). The control device 16 may be configured as a computer system including a processor such as a central processing unit (CPU), a memory such as a random access memory (RAM) and a read only memory (ROM), an input and output device such as a touch panel, a mouse, a keyboard, and a display, and a communication device such as a network card. With regard to the control device 16, a function of the control device 16 is realized by operating each hardware on the basis of control of the processor based on a computer program stored in the memory.

In the first step S1, the workpiece W is irradiated with the pulse laser beam L through the transparent liquid T. The pulse laser beam L is oscillated by the laser oscillator 11, and is transferred to the condensing lens 14 by an optical system including the reflection mirrors 12 and 13. Next, the pulse laser beam L is condensed by the condensing lens 14, and the surface of the workpiece W is irradiated with the pulse laser beam L through the transparent liquid T. Irradiation with the pulse laser beam L is performed in correspondence with an operation of the processing stage 15. Irradiation conditions (for example, a spot diameter, a pulse energy, or an irradiation density) are appropriately set.

When the surface of the workpiece W is irradiated with the pulse laser beam L, laser ablation occurs on the surface of the workpiece W, and plasma is generated. In the air, a material at an irradiation point is gasified. Since the irradiation point in the workpiece W is covered with the transparent liquid T, the plane wave-shaped shock wave due to the plasma is transmitted to the workpiece W. According to this, in a laser peening range of the surface layer portion of the workpiece W, high-density transition occurs in a crystal structure, and a residual compressive stress is applied.

### Second Step

The second step S2 is a step of applying a spherical wave-shaped shock wave or a pressure due to physical contact to the workpiece W after the first step S1 for plastic deformation of the workpiece W. The spherical wave-shaped shock wave is a shock wave that propagates through the inside of the workpiece W in a spherical wave shape centering around a contact point. The spherical wave-shaped shock wave diffuses in various directions at the inside of the workpiece W. The spherical wave-shaped shock wave does not propagate at a deep position from the surface of the workpiece W differently from the plane wave-shaped shock wave, and mainly propagates along the surface of the workpiece W. According to this, the effective processing depth d1 of the workpiece W in the first step S1 is deeper than an effective processing depth d2 of the workpiece W in the second step S2. For example, the effective processing depth d2 is less than 0.3 mm, and may be 50 μm or less.

In the second step S2, the material structure of the workpiece W is transformed by subjecting the workpiece W to plastic deformation. For example, in a case where the workpiece W contains residual austenite as in the vacuum carburizing material, in the second step, the residual austenite of the workpiece W is subjected to deformation-induced martensite transformation. Due to the transformation from the residual austenite to the induced martensite, a volume is expanded. A strain occurs in a parent phase at the periphery of the induced martensite in accordance with the volume expansion. According to this, strain occurs in the parent material at the periphery of the induced martensite. In the second step, a residual austenite amount of the surface layer portion of the workpiece W is reduced by 10 vol % or greater.

Examples of a method of applying the spherical wave-shaped shock wave to the workpiece W include a shot peening, needle peening, ultrasonic peening, hammer peening, barrel polishing, or blasting. In the shot peening, a plurality of peening media (blasting abrasives or shot media) are caused to collide with the surface of the workpiece W at a high speed. The peening media are balls formed from a metal, ceramics, or glass. When performing the shot peening with respect to the workpiece W, shock due to physical collision can be applied to the workpiece W. As a result, the spherical wave-shaped shock wave can be applied to the workpiece W. That is, in the second step S2, the spherical wave-shaped shock wave can be applied to the workpiece W by performing the shot peening to the workpiece W. In other words, in the second step S2, the spherical wave-shaped shock wave can be applied to the workpiece W by physical collision. According to the physical collision, the workpiece W can be easily plastic-deformed. In addition, according to physical collision, a temperature of the surface layer portion of the workpiece W becomes instantaneously high. Due to the temperature rising, the above-described transformation of the material structure is promoted.

Examples of a method of applying a pressure due to physical contact to the workpiece W include vanishing. That is, in the second step S2, for example, a physical spherical wave-shaped shock wave can be applied to the workpiece W by performing vanishing with respect to the workpiece W.

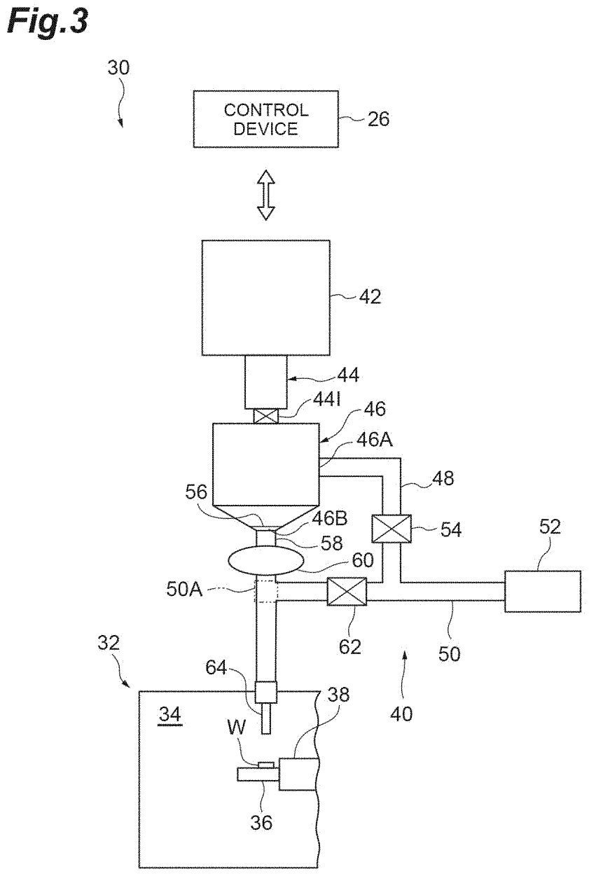

FIG. 3 is a configuration diagram illustrating a shot peening device that is used in the second step. In FIG. 3, a main portion of a shot peening device 30 is schematically illustrated. The shot peening device 30 illustrated in FIG. 3 is a direct pressure type (pressurizing type) shot peening device. Here, description will be given of the direct pressure type, but the shot peening device 30 may be a suction type (gravity type). The shot peening device 30 includes a cabinet 32, a stage 36, a stage holding shaft 38, a blasting device 40, and a control device 26. A processing chamber 34 is formed inside the cabinet 32. In the processing chamber 34, shot peening processing of the workpiece W is performed by causing blasting abrasives to collide with the workpiece W. The stage 36 is provided inside the processing chamber 34. The workpiece W is placed on the stage 36. The stage 36 is held by the stage holding shaft 38.

The blasting device 40 includes a blasting abrasive tank 42, a blasting abrasive supply device (shot hopper) 44, a pressurizing tank 46, a compressor 52, and a nozzle 64. The blasting abrasive tank 42 is connected to the pressurizing tank 46 through the blasting abrasive supply device 44. The blasting abrasive supply device 44 includes a poppet valve 441 provided between the blasting abrasive supply device 44 and the pressurizing tank 46. In a state in which the poppet valve 441 is opened, an appropriate amount of blasting abrasives is transmitted from the blasting abrasive tank 42 to the pressurizing tank 46 through the blasting abrasive supply device 44.

The compressor 52 is connected to the nozzle 64 by a pipe 50. The compressor 52 is also connected to the pressurizing tank 46 by the pipe 50 and a pipe 48. The pipe 48 is branched from the pipe 50, and is connected to an air inlet 46A of the pressurizing tank 46. An air flow rate control valve 54 is provided in the pipe 48. When the air flow rate control valve 54 is opened, compressed air from the compressor 52 is supplied to the pressurizing tank 46 through the pipe 50 and the pipe 48. According to this, the inside of the pressurizing tank 46 is pressurized.

A cut gate 56 is provided in a shot flow outlet 46B of the pressurizing tank 46. A pipe 58 branched from the pipe 50 is connected to the shot flow outlet 46B. In the pipe 50, a connection portion with the pipe 58 is located on a further nozzle 64 side in comparison to a connection portion with the pipe 48. A shot flow rate control valve 60 is provided in the pipe 58. In the pipe 50, an air flow rate control valve 62 is provided between the connection portion with the pipe 58 and the connection portion with the pipe 48. The connection portion with the pipe 58 in the pipe 50 constitutes a mixing portion 50A in which the blasting abrasives supplied from the pressurizing tank 46 and the compressed air supplied from the compressor 52 are mixed. The blasting abrasives and the compressed air are mixed in the mixing portion 50A and the resultant mixture is transmitted to the nozzle 64. The nozzle 64 is disposed at a side portion inside the cabinet 32. The nozzle 64 sprays the compressed air containing the blasting abrasives toward the workpiece W inside the processing chamber 34 to cause the blasting abrasives to collide with the workpiece W.

The shot peening device 30 is controlled by the control device 26. For example, the control device 26 is constituted by a motion controller such as a PLC and a DSP. The control device 26 may be configured as a computer system including a processor such as a CPU, a memory such as a RAM and a ROM, an input and output device such as a touch panel, a mouse, a keyboard, and a display, and a communication device such as a network card. With regard to the control device 26, a function of the control device 26 is realized by operating each hardware on the basis of control of the processor based on a computer program stored in the memory.

The shot peening device 30 includes the blasting device 40 that sprays the blasting abrasives by compressed air, but may include a projecting device that accelerates shot media by an impeller and projects the shot media.

The shot peening device 30 may further include a sorting mechanism, a dust collector, and a circulation device, and may reuse the blasting abrasives. The dust collector is connected to the processing chamber 34 through the sorting mechanism. The dust collector suctions the blasting abrasives dropped to a lower portion of the processing chamber 34 and chips of the workpiece W (generally referred to as power particles), and transfers the dropped blasting abrasives and the chips to the sorting mechanism. For example, the sorting mechanism is a wind power type. The sorting mechanism sorts the transported powder particles into the blasting abrasives that can be used again, and the other fine powders. The other fine powders are recovered by the dust collector. The circulation device supplies the blasting abrasives that can be used again to the blasting abrasive tank 42 through a packet elevator, a screw conveyor, and a separator.

As described above, in the surface treatment method according to the embodiment, since the material structure is subjected to the high-density transition in the first step S1, it is possible to allow the surface layer portion of the workpiece W to have a surface on which a crack is less likely to progress. In addition, since the workpiece W is subjected to the plastic deformation in the second step S2, the surface of the workpiece W can be set as a surface on which a starting point of the crack is less likely to occur. Accordingly, it is possible to provide the surface and the surface layer portion in which occurrence of a crack and progress of the crack are suppressed to the workpiece W by combining the first step S1 and the second step S2. Accordingly, fatigue strength of the workpiece W can be further improved in comparison to the shot peening as in the surface treatment method disclosed in Patent Literature 1.

The effective processing depth d1 of the workpiece W in the first step S1 is deeper than the effective processing depth d2 of the workpiece W in the second step S2. Therefore, the residual compressive stress can be applied to a deeper position from the surface of the workpiece W. In the first step S1, the plane wave-shaped shock wave is applied to the workpiece W by irradiating the workpiece W with a laser wave. Since the laser wave is a high-speed shock wave having directionality, inter-lattice strain is applied in a depth direction. Accordingly, the residual compressive stress can be applied to a deep position.

In the second step S2, the material structure of the workpiece W is transformed by subjecting the workpiece W to plastic deformation. Accordingly, the surface of the workpiece W can be reliably set as a surface on which the starting point of a crack is less likely to occur. In the second step S2, the spherical wave-shaped shock wave is applied to the workpiece W by physical collision. Accordingly, the workpiece W can be easily subjected to the plastic deformation. In the second step S2, the spherical wave-shaped shock wave is applied to the workpiece W by performing shot peening to the workpiece W. The shot peening applies inter-lattice strain in the vicinity of a contact point of the surface of the workpiece W due to physical contact. According to this, it is possible to apply the residual compressive stress to the vicinity of the contact point.

In the second step S2, the material structure of the workpiece W is subjected to deformation-induced martensite transformation. Accordingly, volume expansion occurs in a metal structure, and a strain is caused to occur in a parent phase. According to this, it is possible to apply the residual compressive stress. In the second step S2, the residual austenite amount of the surface layer portion of the workpiece W is reduced by 10 vol % or greater. In this manner, since 10 vol % or greater of residual austenite can be subjected to the deformation-induced martensite transformation, the residual compressive stress can be sufficiently applied.

The invention is not limited to the above-described embodiment, and various modifications can be made within a range not departing from the gist.

Hereinafter, experimental examples will be described.

First, a sample (hereinafter, referred to as “sample NP”) for which the surface treatment according to the embodiment was not performed, a sample (hereinafter, referred to as “sample LP”) for which only the first step (laser peening) was performed, a sample (hereinafter, referred to as “sample SP”) for which only the second step (shot peening) was performed, and a sample (hereinafter, referred to as “sample LP+SP”) for which the surface treatment according to the embodiment was performed, that is, the second step was performed after performing the first step was prepared. Each sample was prepared by using chrome molybdenum steel (JIS standard: SCM420H) subjected to a vacuum carburization treatment so that an effective case depth (ECD) becomes approximately 0.7 mm.

The laser peening was performed under conditions in which a spot diameter was set to 1.0 mm, pulse energy was set to 987 mJ, and an irradiation density is set to 98 pulses/mm².

The shot peening was performed by using a shot (AM50B) constituted by an amorphous round metal ball under conditions in which a blasting pressure was set to 0.5 MPa, a blasting amount was set to 13.5 kg/min, a coverage was set to 300% or greater, and a sample movement speed was set to 1800 mm/min. An arc height measured by using an almen strip was 0.275 mmN.

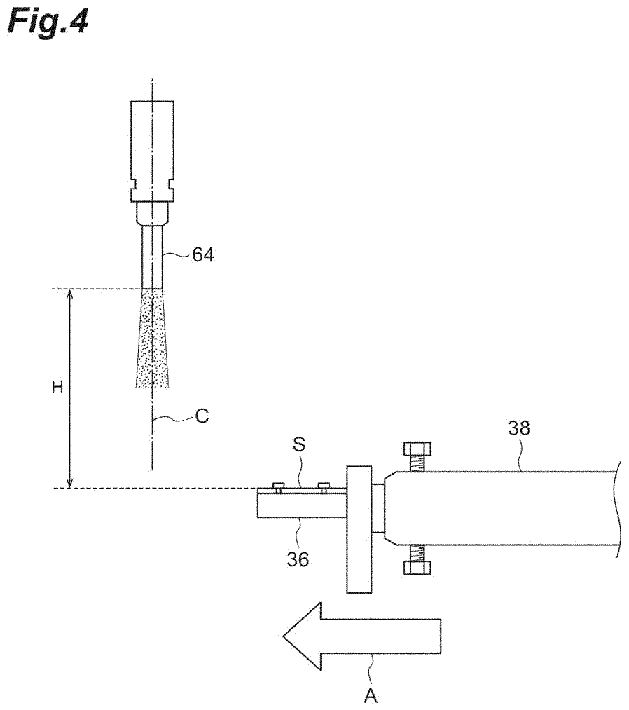

FIG. 4 is a view illustrating a method of measuring the arc height. In FIG. 4, the same reference numeral as in FIG. 3 is given to portions common to those in FIG. 3. As illustrated in FIG. 4, a distance H from a tip end of the nozzle 64 to a surface of an almen strip S along a central axis C of the nozzle 64 was set to 200 mm. The almen strip S was moved by moving the stage 36 on which the almen strip S was placed along an arrow A, and the shot peening was performed under the above-described conditions.

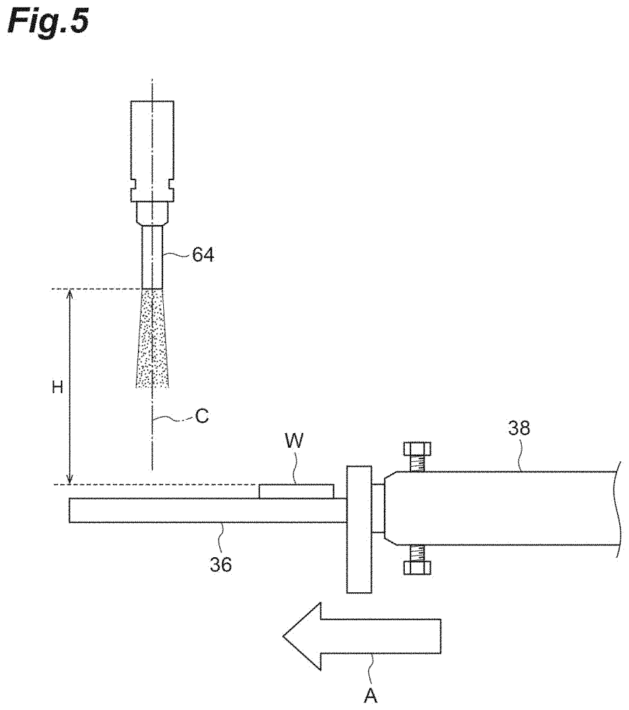

FIG. 5 is a view illustrating a method of performing shot peening for a sample. In FIG. 5, the same reference numeral as in FIG. 3 is given to portions common to those in FIG. 3. As illustrated in FIG. 5, the distance H from the tip end of the nozzle 64 to the surface of the workpiece W that was a sample along the central axis C of the nozzle 64 was set to 200 mm. The workpiece W was moved by moving the stage 36 on which the workpiece W was placed along an arrow A, and the shot peening was performed under the above-described conditions.

### Residual Stress

A residual stress of each sample was measured. The residual stress was measured by using a residual stress measuring device μ-X360 manufactured by Pulstec Industrial Co., Ltd. in accordance with a cosα method. A Cr bulb was used, an irradiation diameter ϕ was set to 1.0 mm, a collimate diameter ϕ was set to 1 0 mm, and a measurement angle was set to 35°.

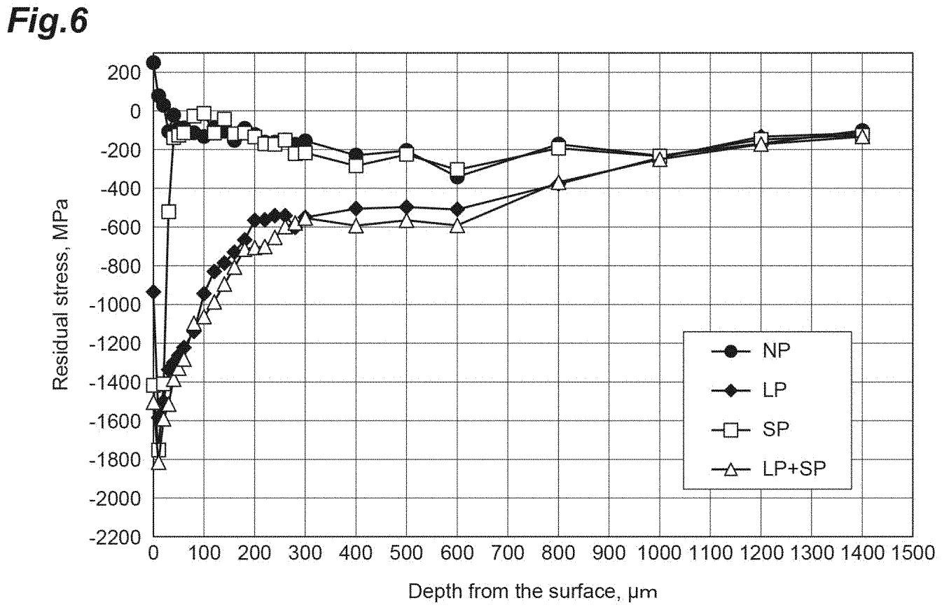

FIG. 6 is a graph illustrating measurement results of the residual stress. In FIG. 6, the horizontal axis represents a depth (μm) from a surface of the sample, and the vertical axis represents the residual stress (MPa). A negative value is a compressive stress, and a positive value is a tensile stress.

As illustrated in FIG. 6, in the sample LP and the sample LP+SP for which the first step was performed, the residual compressive stress was applied to a depth of 1 mm from the surface. That is, the effective processing depth in the first step was 1 mm. In the sample SP for which only the second step was performed, the residual compressive stress was applied to a depth of 50 μm from the surface of the sample. That is, the effective processing depth in the second step was 50 μm.

In the sample LP and the sample LP+SP, particularly, a value of the residual compressive stress is great in a depth range from 10 μm to 50 μm. In the sample LP for which only the first step was performed, a value of the residual compressive stress was small in the outermost layer. As described above, according to the laser peening, it is considered that the residual compressive stress can be applied to a deep position of the sample, but in the outermost layer of the sample, the residual compressive stress cannot be sufficiently applied due to a thermal influence by laser irradiation.

In the sample LP+SP, a value of the residual compressive stress in the outermost layer of the sample becomes larger in comparison to the sample LP. As described above, it could be seen that the residual compressive stress can be sufficiently applied to the outermost layer of the sample when performing the shot peening after the laser peening. Note that, in a case of performing the laser peening after the shot peening, the thermal influence by the laser irradiation remained in the outermost layer of the sample, and the residual compressive stress was not sufficiently applied.

### Residual Austenite Amount

A residual austenite amount of each sample was measured. The residual austenite amount was measured by using a residual stress measuring device μ-X360 manufactured by Pulstec Industrial Co., Ltd. in accordance with a cosα method. A Cr bulb was used, an irradiation diameter ϕ was set to 1.0 mm, a collimate diameter ϕ was set to 1.0 mm, and a measurement angle was set to 0°.

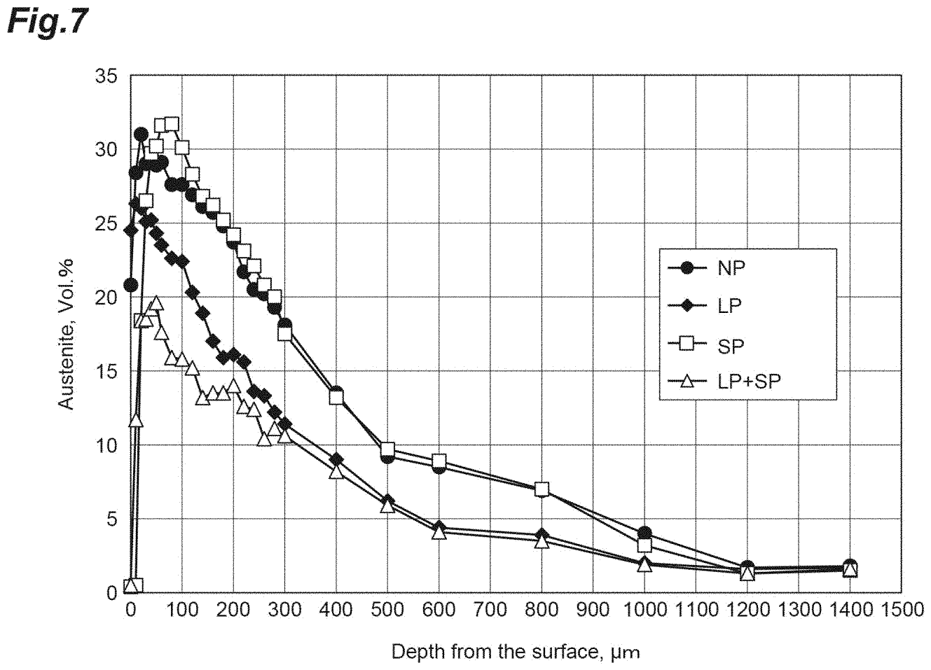

FIG. 7 is a graph illustrating measurement results of the residual austenite amount. In FIG. 7, the horizontal axis represents a depth (μm) from the surface of the sample, and the vertical axis represents the residual austenite amount (vol %). The residual austenite is a crystal having a volume, but an area % of the residual austenite on a cross-section orthogonal to a depth direction of the sample was set as the residual austenite amount (vol %) for convenience. As illustrated in FIG. 7, the residual austenite amount in the outermost layer was 20 vol % or greater in the sample NP for which the surface treatment was not performed, and the residual austenite amount was approximately 0 (less than 1 vol %) in the sample SP and the sample LP+SP for which the second step was performed. It is considered that 20 vol % or greater of residual austenite was subjected to the deformation-induced martensite transformation due to the second step.

### Hardness

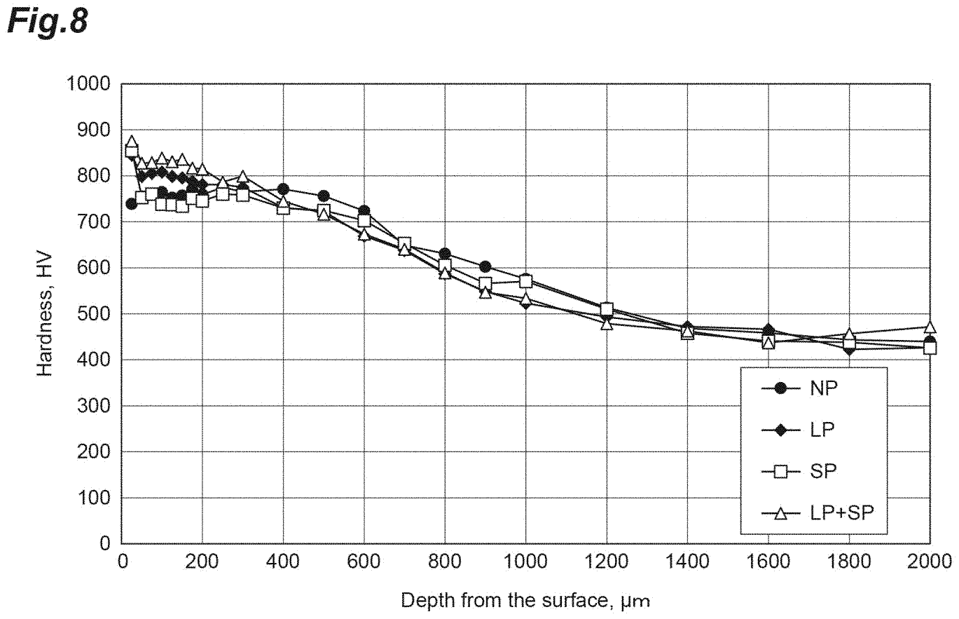

Hardness of each sample was measured. The hardness was measured by using a hardness tester HM manufactured by Mitutoyo Corporation. FIG. 8 is a graph illustrating measurement results of hardness. In FIG. 8, the horizontal axis represents a depth (μm) from the surface of the sample, and the vertical axis represents Vickers hardness. As illustrated in FIG. 8, it could be seen that the sample LP+SP is harder than the sample LP and the sample SP at a depth of 0 μm to 400 μm. It could be seen that in the sample SP, hardness is imparted to an outermost layer but hardness is not imparted at a deep position of 50 μm or greater.

### Strain Amount

A kernel average misorientation (KAM) value of each sample was measured by using a scanning electron microscope SM-7200F manufactured by JEOL Ltd. The KAM value is a numerical value indicating a local orientation difference that is a difference in a crystal orientation between adjacent measurement points in a crystal orientation analysis based on an electron back scatter diffraction (EBSD) method. The KAM value is a parameter that quantitively evaluates a strain amount. The larger the KAM value is, the larger the local orientation difference in crystal grains is. That is, the larger the KAM value is, the larger the strain amount becomes.

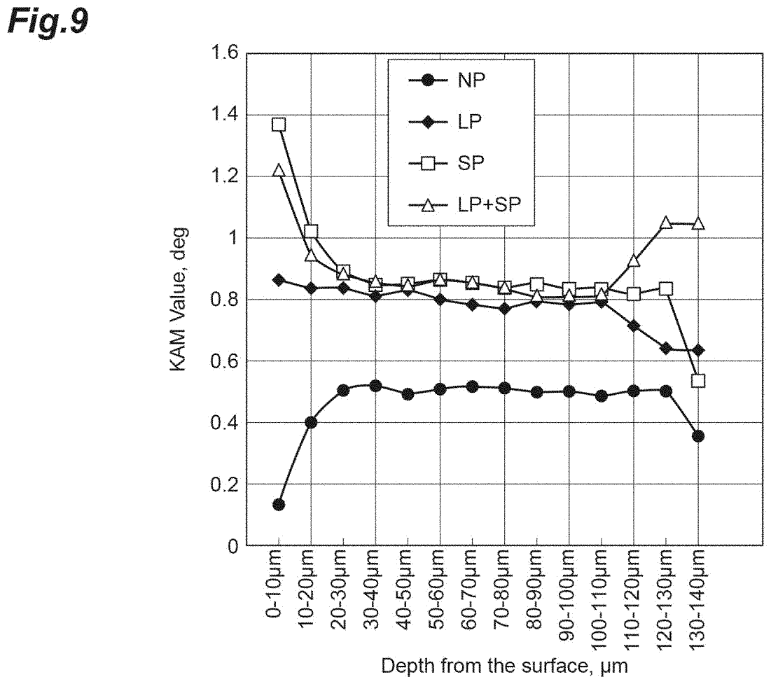

FIG. 9 is a graph illustrating measurement results of the KAM value. In FIG. 9, the horizontal axis represents a depth range (μm) from the surface of the sample, and the vertical axis represents an average KAM value (deg) in each depth range. As illustrated in FIG. 9, in the sample NP, the average KAM value at the outermost layer (depth: 0 to 10 μm) was approximately 0.1 deg. The KAM value increased as going to an inner side up to a depth of 30 μm, and was steady near approximately 0.5 deg at the depth of 30 μm or more. In the sample NP, it is considered that the KAM value was steady at approximately 0.5 deg due to initial strain by a heat treatment. It is considered that constraint force from a surface side did not exist at the outermost layer (depth: 0 to 10 μm), and thus the KAM value was approximately 0.1 deg.

In the sample LP, the KAM value becomes approximately 0.8 deg up to a depth of 110 μm, and becomes larger than results of the sample NP. The KAM value at the depth of 110 μm or more decreases, and is slightly higher in comparison to the sample NP. According to the measurement results of the residual austenite amount illustrated in FIG. 7, a difference between the residual austenite amount of the sample NP, and the residual austenite amount of the sample LP is approximately the same over a depth of 10 μm to 200 μm. That is, it is considered that an influence by martensite transformation due to laser peening is approximately the same over the depth of 10 μm to 200 μm. Accordingly, it is considered that a decrease in the KAM value of the sample LP at a depth of 110 μm or more is caused by weakened constraint force on an inner side.

In the sample SP, the KAM value at the outermost layer (depth: 0 to 10 μm) is 1.4 deg. The KAM value of the sample SP decreases as going to an inner side and becomes close to 0.8 deg at a depth of 30 μm or more. The KAM value of the sample SP becomes larger in comparison to the KAM value of the sample NP. The KAM value of the sample SP becomes higher than the KAM value of the sample LP up to a depth of 130 μm. The KAM value of the sample SP rapidly decreases at the depth of 130 μm or more, and becomes a value slightly lower than the KAM value of the sample LP.

The cause of the increase in the KAM value in the sample SP is as follows. Volume expansion occurs in a metal structure due to the deformation-induced martensite transformation, and thus large strain occurs. According to the measurement results of the residual austenite amount illustrated in FIG. 7, a difference between the residual austenite amount of the sample NP and the residual austenite amount of the sample LP is the maximum at a depth of 0 μm, decreases as going to an inner side, and becomes 0 at a depth of 40 μm. That is, it is considered that the influence by the martensite transformation due to the shot peening is the maximum at the depth of 0 μm, decreases as going to an inner side, and does not exist at the depth of 40 μm or more. From the results, it is considered that the KAM value of the sample SP shows an attenuation direction up to a depth of 40 μm, and since the influence by the martensite transformation disappears after the depth, the KAM value becomes approximately 0.8 deg due to an influence by an in-grain strain. It is considered that since the influence by the martensite transformation and the in-grain strain does not exist at a portion deeper than 130 μm, the KAM value decreases to a value that is approximately the same as in the sample NP having the initial strain.

The KAM value of the outermost layer (depth: 0 to 10 μm) in the sample LP+SP is 1.2 deg. The KAM value of the sample LP+SP decreased as going to an inner side, became the same as the KAM value of the sample LP and the sample SP at a depth of 30 μm or more, and increased up to approximately 1 at a depth of 120 μm or more. The cause of the increase in the KAM value of the sample LP+SP is as follows. In addition to the plastic deformation due to the laser peening, volume expansion occurs in a metal structure due to the deformation-induced martensite transformation, and thus a large strain occurs.

### Surface Roughness

Surface roughness of each sample was measured. The surface roughness was measured by using Surfcom1400 manufactured by TOKYO SEIMITSU CO., LTD. in accordance with JIS B0601;2001 that is JIS standard of the surface roughness. With respect to each sample, a surface roughness curve was acquired three times, and arithmetic average roughness Ra, an average value thereof, a maximum height Rz, and an average value thereof were obtained. Table 1 shows measurement results of arithmetic average roughness Ra. Table 2 shows measurement results of the maximum height Rz.

TABLE 1

| Sample | Ra | | | Average value |
|---|---|---|---|---|
| NP | 0.2425 | 0.2371 | 0.2677 | 0.2491 |
| LP | 0.6892 | 0.6896 | 0.6832 | 0.6873 |
| SP | 0.3184 | 0.2906 | 0.3108 | 0.3066 |
| LP + SP | 0.5110 | 0.5170 | 0.5032 | 0.5104 |

TABLE 2

| Sample | Rz | | | Average value |
|---|---|---|---|---|
| NP | 1.6976 | 1.6387 | 1.6168 | 1.6510 |
| LP | 4.6548 | 5.1180 | 4.4321 | 4.7350 |
| SP | 2.0875 | 2.2672 | 2.0523 | 2.1357 |
| LP + SP | 3.5160 | 3.5594 | 3.0752 | 3.3835 |

As shown in Table 1 and Table 2, the surface roughness of the sample LP is the highest. It is considered that in the sample LP, surface accuracy deteriorates due to a thermal influence by the laser peening. The surface roughness of the sample SP is higher than the surface roughness of the sample NP, but is lower than the surface roughness of the sample LP and the sample LP+SP for which the laser peening was performed. It could be seen that deterioration of the surface accuracy can be prevented according to the shot peening. The surface roughness of the sample LP+SP is lower than the surface roughness of the sample LP. It is considered that the surface accuracy deteriorated due to the laser peening is improved due to the shot peening.

### REFERENCE SIGNS LIST

W: workpiece.

1: A surface treatment method comprising:
a first step of applying a plane wave-shaped shock wave to a workpiece to cause high-density transition to occur in a material structure of the workpiece; and
a second step of applying a spherical wave-shaped shock wave or a pressure due to physical contact to the workpiece after the first step for plastic deformation of the workpiece.

2: The surface treatment method according to claim 1,
wherein in the second step, the material structure of the workpiece is transformed by subjecting the workpiece to plastic deformation.

3: The surface treatment method according to claim 1,
wherein in the second step, the spherical wave-shaped shock wave is applied to the workpiece by physical collision.

4: The surface treatment method according to claim 1,
wherein an effective processing depth of the workpiece in the first step is deeper than an effective processing depth of the workpiece in the second step.

5: The surface treatment method according to claim 1,
wherein an effective processing depth of the workpiece in the first step is 0.3 mm or greater, and
an effective processing depth of the workpiece in the second step is 50 μm or less.

6: The surface treatment method according to claim 1,
wherein in the second step, the material structure of the workpiece is subjected to deformation-induced martensite transformation.

7: The surface treatment method according to claim 1,
wherein in the first step, the plane wave-shaped shock wave is applied to the workpiece by irradiating the workpiece with a laser wave, and
in the second step, the spherical wave-shaped shock wave is applied to the workpiece by performing shot peening to the workpiece.

8: The surface treatment method according to claim 1,
wherein in the second step, a residual austenite amount of the workpiece is reduced by 10 vol % or greater.

9: The surface treatment method according to claim 2,
wherein in the second step, the spherical wave-shaped shock wave is applied to the workpiece by physical collision.

10: The surface treatment method according to claim 2,
wherein an effective processing depth of the workpiece in the first step is deeper than an effective processing depth of the workpiece in the second step.

11: The surface treatment method according to claim 3,
wherein an effective processing depth of the workpiece in the first step is deeper than an effective processing depth of the workpiece in the second step.

12: The surface treatment method according to claim 2,
wherein an effective processing depth of the workpiece in the first step is 0.3 mm or greater, and
an effective processing depth of the workpiece in the second step is 50 μm or less.

13: The surface treatment method according to claim 3,
wherein an effective processing depth of the workpiece in the first step is 0.3 mm or greater, and
an effective processing depth of the workpiece in the second step is 50 μm or less.

14: The surface treatment method according to claim 4,
wherein an effective processing depth of the workpiece in the first step is 0.3 mm or greater, and
an effective processing depth of the workpiece in the second step is 50 μm or less.

15: The surface treatment method according to claim 2,
wherein in the second step, the material structure of the workpiece is subjected to deformation-induced martensite transformation.

16: The surface treatment method according to claim 3,
wherein in the second step, the material structure of the workpiece is subjected to deformation-induced martensite transformation.

17: The surface treatment method according to claim 4,
wherein in the second step, the material structure of the workpiece is subjected to deformation-induced martensite transformation.

18: The surface treatment method according to claim 5,
wherein in the second step, the material structure of the workpiece is subjected to deformation-induced martensite transformation.

19: The surface treatment method according to claim 2,
wherein in the first step, the plane wave-shaped shock wave is applied to the workpiece by irradiating the workpiece with a laser wave, and
in the second step, the spherical wave-shaped shock wave is applied to the workpiece by performing shot peening to the workpiece.

20: The surface treatment method according to claim 2,
wherein in the first step, the plane wave-shaped shock wave is applied to the workpiece by irradiating the workpiece with a laser wave, and
in the second step, the spherical wave-shaped shock wave is applied to the workpiece by performing shot peening to the workpiece.
